(19) United States
(12) Patent Application Publication
(10) Pub. No.: US 2025/0293516 A1
(43) Pub. Date: Sep. 18, 2025

(54) SYSTEMS AND METHODS FOR INITIATING POWER GENERATION

(71) Applicant: Toyota Motor Engineering & Manufacturing North America, Inc., Plano, TX (US)

(72) Inventors: Daniel Charles Folick, Long Beach, CA (US); Matthew K. McClory, Aliso Viejo, CA (US); Dakota Kelley, Garland, TX (US)

(73) Assignee: Toyota Motor Engineering & Manufacturing North America, Inc., Plano, TX (US)

(21) Appl. No.: 19/222,280

(22) Filed: May 29, 2025

Related U.S. Application Data
(63) Continuation of application No. 17/565,598, filed on Dec. 30, 2021, now abandoned.

(51) Int. Cl. H02J 1/10; H01M 8/04298; H01M 8/04992; H01M 16/00; H02J 1/00; H02J 9/06

(52) U.S. Cl. CPC H02J 1/106; H01M 8/04298; H01M 8/04992; H01M 16/006; H02J 1/00; H02J 9/062; H01M 2220/10; H01M 2250/10

(57) ABSTRACT

Systems, methods, and other embodiments described herein relate to safely activating a fuel cell (FC) within a generator. In one embodiment, a method includes initiating a test for sensitive systems of a generator during a standby status using backup power including a battery. The method also includes powering an FC and a direct current (DC) converter on a first bus within the generator by increasing an operational voltage on a second bus using the battery. The method also includes, upon successfully completing the test and powering the FC and the DC converter, energizing a load inverter by switching power flow from the battery to the FC after completing a non-critical sequence that controls support systems of the generator for a generating status, wherein the DC converter stabilizes voltage energy between the FC directly connected on the first bus above a minimum voltage and output energy to the second bus.

### CROSS-REFERENCE TO RELATED APPLICATIONS

This application is a continuation application of U.S. application Ser. No. 17/565,598, filed on Dec. 30, 2021, which is herein incorporated by reference in its entirety.

### TECHNICAL FIELD

The subject matter described herein relates, in general, to operating a power generator, and, more particularly, to activating a fuel cell and components of the power generator safely using a control sequence.

### BACKGROUND

Systems use various energy resources to generate power. For example, a generator uses propane, natural gas, or kerosene as an energy resource to produce electricity for a building. Such generators are used for supplying regular power or as standby in the event that the primary power is lost. These generators use a motor that energizes a dynamo to produce direct current (DC) or an alternator to produce alternating current (AC) and output electrical power. In either case, the durability and life of the motor, dynamo, or alternator diminish through mismanaged control. For instance, mechanical components wear out sooner when the control system under-delivers power to a load in the building.

Similar to other resources, a generator can use a fuel cell (FC) to efficiently power an electrical load. An FC converts hydrogen fuel and oxygen to produce DC power. An inverter can convert the DC power to AC power for powering a commercial or a residential building. Depending on system control, the water and excess heat generated by FCs reduce efficiency and increase the risk of damaging electrical components in the system. Furthermore, a control system mismanaging transitions of the FC can increase heat and energy imbalances on an electrical bus, thereby reducing the life of the electrical components. In particular, the control system can damage an FC or sensitive electronics of the generator when rapidly transitioning to a generating status from standby.

### SUMMARY

In one embodiment, example systems and methods relate to safely activating a fuel cell (FC) within a generator. In various implementations, generators encounter difficulties energizing or starting components safely while maintaining durability and lifespan. For example, a controller of an FC abruptly changing power levels during a status change can prematurely wear an electrical bus or subsystems of the generator. In certain circumstances, a sensitive component fails due to heat when a controller mismanages temperature control and the sensitive component overheats during status changes. Therefore, in one embodiment, an activation system implements control sequences that test sensitive systems (e.g., a high-voltage electrical bus) and powers the FC and a direct current (DC) converter enclosed within a generator before entering a generating status, thereby increasing durability and safety. Here, the FC and the DC converter use a battery for transitioning to the generating status by gradually increasing voltage levels on sensitive buses and performing a startup sequence by the FC. The activation system also energizes, using the battery, a load inverter that powers a load (e.g., a building or device) if system tests are successful and after a non-critical sequence. In one approach, this non-critical sequence starts up components by managing the temperature and the produced water of the FC.

Furthermore, the activation system executes other tasks using the battery for safety and entering the generating status. In one approach, the activation system instructs the load inverter to implement a boot sequence and transitions to the FC from battery power after completing the boot sequence for regulating the voltage of sensitive buses. Also, the activation system energizes the load inverter for converting the DC power from the FC to an alternating current (AC) level that powers a load and bringing the FC completely online. The load inverter then couples to the load and the activation system switches the generator to the generating status, thereby completing the activation. Accordingly, the activation system prevents damage to the FC, the DC converter, and the sensitive components within the generator and increases safety by following the control sequences.

In one embodiment, an activation system for safely activating an FC within a generator is disclosed. The activation system includes one or more processors and a memory communicably coupled to the one or more processors and storing a control module including instructions that, when executed by the one or more processors, cause the one or more processors to initiate a test for sensitive systems of a generator using backup power including a battery. The instructions also include instructions to power an FC and a DC converter within the generator to an operational level using the battery, wherein the DC converter stabilizes a circuit fed by the FC. The instructions also include instructions, upon successfully completing the test and powering the FC and the DC converter, to energize a load inverter after completion of a non-critical sequence that controls support systems of the generator, wherein the DC converter stabilizes energy between the FC, the battery, and the load inverter.

In one embodiment, a non-transitory computer-readable medium for safely activating an FC within a generator and including instructions that when executed by a processor cause the processor to perform one or more functions is disclosed. The instructions include instructions to initiate a test for sensitive systems of a generator using backup power including a battery. The instructions also include instructions to power an FC and a DC converter within the generator to an operational level using the battery, wherein the DC converter stabilizes a circuit fed by the FC. The instructions also include instructions, upon successfully completing the test and powering the FC and the DC converter, to energize a load inverter after completion of a non-critical sequence that controls support systems of the generator, wherein the DC converter stabilizes energy between the FC, the battery, and the load inverter.

In one embodiment, a method for safely activating an FC within a generator is disclosed. In one embodiment, the method includes initiating a test for sensitive systems of a generator using backup power including a battery. The method also includes powering an FC and a DC converter within the generator to an operational level using the battery, wherein the DC converter stabilizes a circuit fed by the FC. The method also includes, upon successfully completing the test and powering the FC and the DC converter, energizing a load inverter after completing a non-critical sequence that controls support systems of the generator, wherein the DC converter stabilizes energy between the FC, the battery, and the load inverter.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a generator having fuel cells (FC) within which systems and methods disclosed herein may be implemented.

FIG. 2 illustrates one embodiment of an activation system that is associated with safely activating the generator having FCs and entering a generating status.

FIG. 3 illustrates control sequences used by the activation system to safely activate the generator having FCs.

FIG. 4 illustrates one embodiment of a method that is associated with testing, activating, transitioning to the generating status by the generator having FCs.

### DETAILED DESCRIPTION

Systems, methods, and other embodiments associated with safely activating a fuel cell (FC) within a generator are disclosed herein. In various implementations, generators using FCs encounter difficulties energizing or starting components safely. This can reduce the durability and lifespan of a generator having FCs. For example, a logic controller of an FC abruptly changing power levels can prematurely wear an electrical bus and damage water pumps when transitioning to a generating status. Therefore, in one embodiment, an activation system implements a control sequence to energize and start FCs, direct current (DC) converters, and a load inverter in a generator safely for entering the generating status. The activation system initially tests sensitive components of the generator to identify errors or malfunctions and powers the FCs and the DC converters for operation. Also, at this point the activation system through the DC converters begins increasing a voltage level for an electrical bus used by the FCs by drawing power from the battery. In one approach, the voltage level is an operational level for safely starting the FCs and entering the generating status. Here, the DC converters manage a DC voltage that is balanced between different electrical buses from the varying DC power outputted by the FCs, thereby providing constant power to the load inverter. Balancing of voltage on the electrical buses also addresses irregular power draws by the FCs that can damage sensitive electronics.

As the activation system performs testing of the sensitive components, the FCs follow an initiation sequence that opens fuel valves, activates pumps, adjusts sensors, and sets temperatures for full operation. Next, the activation system completes the test for the sensitive components and begins testing non-critical components by following a non-critical sequence if the test did not generate an error or fault. For example, the activation system checks HVAC statuses, levels for reservoirs, and non-critical alarms during the non-critical sequence.

Moreover, the activation system energizes the load inverter upon completion of the non-critical sequence. Correspondingly, the electrical buses coupled to the DC converters are energized by the activation system above a voltage level for powering a load (e.g., a building or a device) by the load inverter and the FCs. The activation system then transitions the load from the battery to the FCs for power generation. Accordingly, the activation system measures the load and sends a power request to certain FCs that energize and match the load demand. The activation system then transitions the generator to the generating status after a transient response of the FCs. In one approach, the battery buffers the transient response by regulating the voltage levels on buses drawn by the load inverter. In this way, the activation system improves operation whereby the power to the load is stable, sensitive components are protected from irregular voltages, and the generator safely enters the generating status.

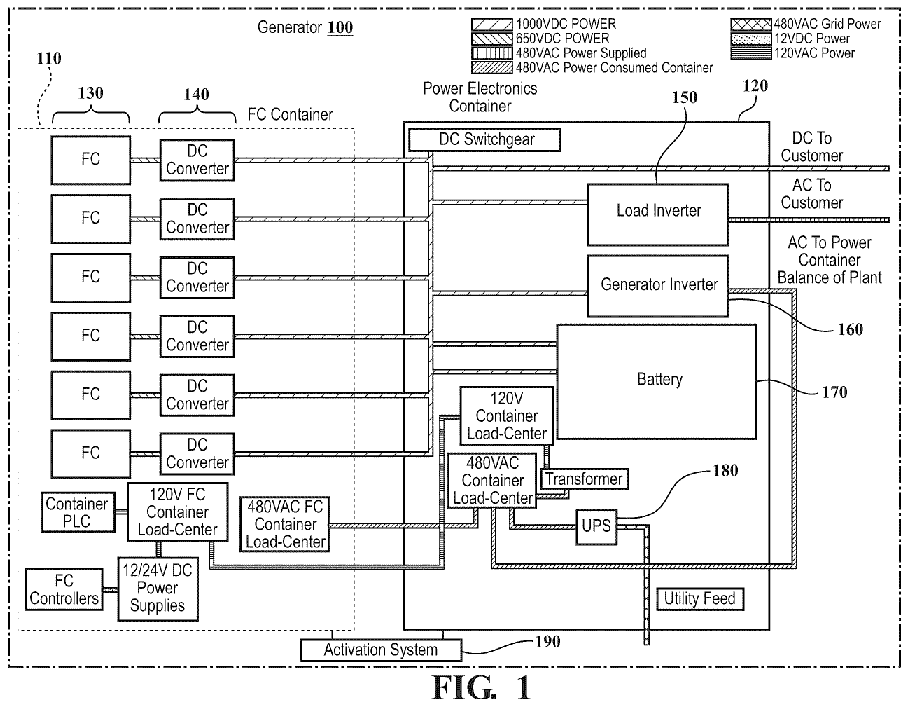

Now turning to FIG. 1, one embodiment is illustrated of a generator 100 having FCs within which systems and methods disclosed herein may be implemented. As explained below, the generator 100 is controlled by an activation system 190 to test and energize components associated with the generator including the FC for entering a generating status. In one approach, this involves gradually powering up sensitive, non-critical, or other components of the generator 100. Furthermore, testing may involve increasing subcomponent energy, opening valves, and checking pressure for a system to safely enter the generating status. In this way, the activation system increases the durability and the lifespan of the generator 100 by following a control sequence.

Moreover, the generator 100 includes an FC container 110 and a power electronics container 120. The FC container 110 houses the FCs 130 (e.g., 24 FCs) that are each electrically coupled to an electrical bus, thereby forming a power bank or center. Each electrical bus of the FCs is regulated by one of DC converters 140 that maintains and stabilizes a voltage level using a transistor circuit and power from multiple sources. Here, the DC converters 140 efficiently produce a DC voltage (e.g., 650 Volts DC (VDC)) consistently on each electrical bus from the varying DC power outputted by the FCs 130. As explained below, the voltage on the electrical bus may also vary irregularly due to a balance of plant (BOP) of the FCs 130 drawing power for operation. At the same time, the DC converters 140 output a same or a different voltage level on a bus used by a load inverter 150 (e.g., a 1.5 megawatt (MW) inverter) or a generator inverter 160 (e.g., a 125 kilowatt (kW) inverter) for conversions to AC power. For example, the activation system 190 may instruct the DC converters 140 to deliver 1000 VDC to the load inverter 150 or the generator inverter 160 using a DC switchgear associated with the power electronics container 120. Related to voltage stability, the DC converters 140 prevent unusual voltage levels from creating current that damages electrical buses or wires of the generator 100.

Moreover, the DC switchgear controls and protects the DC converters 140, the load inverter 150, and the battery 170 during power delivery to a load. Power delivery from the FCs 130 is otherwise less reliable without the DC converters 140 due to irregularities associated with converting hydrogen to electricity. The irregularities can damage electrical buses, controllers, and other electronics of the generator 100.

In various implementations, a load-center for the FC container operating at a certain voltage (e.g., 120 VAC) may receive commands from a container programmable logic controller (PLC) controlled by the activation system 190. A load-center provides power, circuit control, fuses, and overcurrent protection to internal loads (e.g., power supplies, fans, or sensors) of the generator 100. As such, the load-centers in the generator 100 distribute power to various components operating at different voltage levels. Here, a load-center may power a BOP associated with the FCs 130 and other loads for the generator 100. Furthermore, the activation system 190 may use PLC commands to change power levels, operate the ignition, communicate with the load-center of the power electronics container 120, and the FC controllers. For example, the container PLC forms and sends a request for generating power to a gateway electronics control unit (ECU) during a generating status. This may also include coordinating with a PLC of the power electronics container 120 during the generating status.

As explained below, the activation system 190 may coordinate with the container PLC to control components of the FC container 110 and the power electronics container 120 during status transitions. During the generating status, a gateway ECU uses ignition power (e.g., low-voltage 12 VDC) controlled by the container PLC and processes the request accordingly. In various implementations, the gateway ECU may be a component of the FC controllers and situated proximate to the container PLC. In one approach, the activation system 190 uses the ignition systems to turn on electronics without the FCs 130. Subsequently, the FCs 130 generate power and energize the 650 VDC electrical bus according to the signaling from the gateway ECU.

Regarding more details on the generating status, the FCs 130 use hydrogen (H₂) and oxygen in a reaction to generate power. Heating is controlled for the FC container 110 and a battery 170 (e.g., a 1000 volt pack) by the generator 100. In particular, coolant flows through the FC container 110 to each of the FCs 130 for maintaining safe temperatures during operation. Concurrently, louvers for the heating, venting, and air conditioning (HVAC) system are open for temperature control. Furthermore, the generator 100 monitors internal temperatures of the FC container 110 or a power electronics container 120 and controls fans (e.g., cooling or heating) accordingly. Safety alarms are triggered by the generator 100 if operating temperatures go beyond a target range, during a power surge, or a gas leak.

Concerning the power electronics container 120, in one approach the DC converters 140 may feed 1000 VDC directly to a load. The load inverter 150 on the other hand delivers AC power (e.g., 480 VAC) to the load. Furthermore, the generator 100 uses the generator inverter 160 to deliver power (e.g., 480 VAC) for the BoP of the FCs 130 or other components. A BoP has components used by the FCs 130 to convert fuel to electricity that the activation system 190 initiates for entering the generating status. For example, the components are pumps (e.g., hydrogen pump and water pump), sensors, heat exchangers, gaskets, air compressors, recirculation blowers, and humidifiers used by the FCs 130. Accordingly, the generator inverter 160 can power the high-voltage load-centers of the FC container 110 and the power electronics container 120 using energy from the FCs 130. In one approach, an uninterrupted power supply (UPS) uses utility power (e.g., 480 VAC) to power load-centers of the FC container 110 and the power electronics container 120. This operation may be helpful during the startup or faults of the FCs 130.

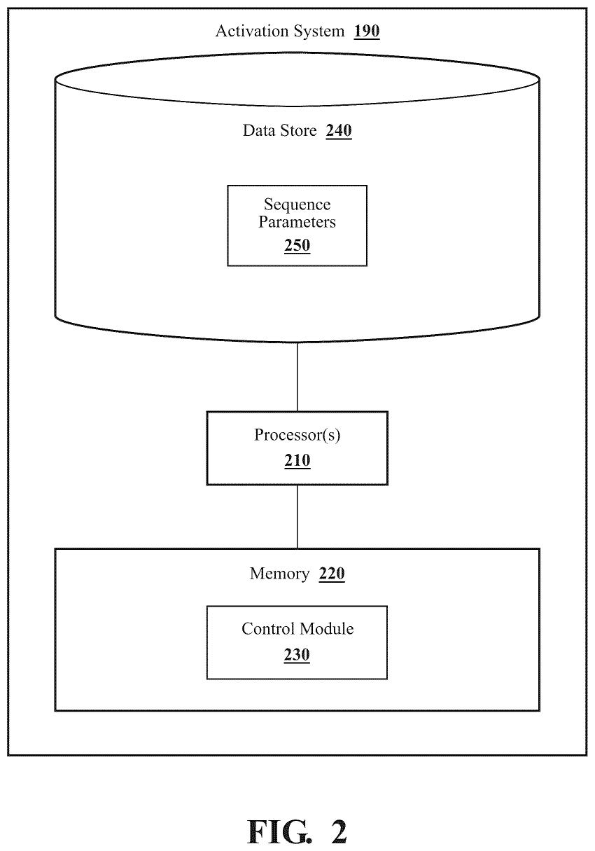

With reference to FIG. 2, one embodiment of an activation system 190 of the generator 100 is illustrated. The activation system 190 is shown as including a processor(s) 210. In one embodiment, the activation system 190 includes a memory 220 that stores a control module 230. The memory 220 is a random-access memory (RAM), a read-only memory (ROM), a hard-disk drive, a flash memory, or other suitable memory for storing the control module 230. The control module 230 is, for example, computer-readable instructions that when executed by the processor(s) 210 cause the processor(s) 210 to perform the various functions disclosed herein.

The activation system 190 as illustrated in FIG. 2 is generally an abstracted form. With reference to FIG. 2, the control module 230 generally includes instructions that function to control the processor(s) 210 to test or energize components of the generator 100 as explained in detail below. Moreover, in one embodiment, the activation system 190 includes a data store 240. In one embodiment, the data store 240 is a database. The database is, in one embodiment, an electronic data structure stored in the memory 220 or another data store and that is configured with routines that can be executed by the processor(s) 210 for analyzing stored data, providing stored data, organizing stored data, and so on. Thus, in one embodiment, the data store 240 stores data used by the control module 230 in executing various functions.

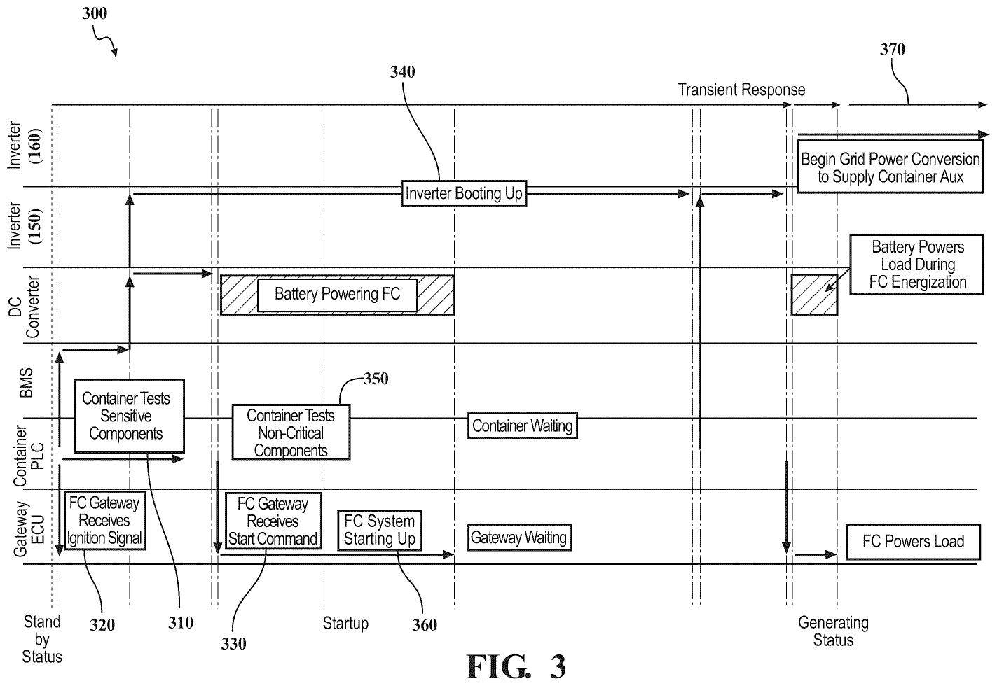

Furthermore, the data store 240 includes the sequence parameters 250 for the generator 100. These sequence parameters 250 include commands, control signals, temperature ranges, bus voltages, valve statuses, alarm types, fault codes, and so on associated with the activation system 190 testing or energizing components used by the generator 100 for entering a generating status. In particular, the control module 230 includes instructions that cause the processor(s) 210 to safely test and energize components of the generator 100 having the FCs 130 for startup as illustrated in FIG. 3.

The sequence 300 in FIG. 3 involves the gateway ECU, the container PLC, a battery management system (BMS), and the activation system 190 transitioning components through standby and generating statuses. The activation system 190 receives a signal that power is lost to a load (e.g., a building or device). This may be losing utility power caused by a storm, another generator going offline, or a time-of-day. At this time, the generator 100 is in the standby status. In one approach, the standby status involves providing power to a controller of the power electronics container 120 and monitoring safety alarms. In this way, the controller is ready to receive a startup command from the container PLC for the next exit from the standby status. In addition, during the standby status the gateway ECU receives low-voltage power without a signal to the ignition from the container PLC. This reduces the gateway ECU transition time to the generating status from standby. Regarding control values, the hydrogen valve is closed and waiting to supply fuel for the next exit from the standby status. The purge valve for the hydrogen and nitrogen valve are also closed since they are non-critical to the FCs 130 during the standby status.

Moreover, the standby status may involve cooling at a low flow-rate by adjusting the request valve for standby. As such, the activation system 190 prevents freezing of the FCs 130 in certain climates. The activation system 190 also maintains targets for temperatures associated with the FCs 130 by adjusting supply/bypass valves. Similarly, the HVAC monitors temperatures internal to the FC container 110 and adjusts fans or heaters accordingly.

Next, the activation system 190 begins tests for sensitive components at 310, such as by using power from the uninterrupted power supply (UPS) 180. These tests involve checking proper operation and statuses of alarms, the container PLC, FC subsystems, cooling temperature, gas pressure/levels, and low-voltage power supplies. An error, no response, or abnormal operation here causes the sequence 300 to abort from malfunction. This effectively protects sensitive components of the generator 100. Then, at 320 the activation system 190 instructs the container PLC to signal a low-voltage ignition power to the gateway ECU and an ECU of an FC for initiation. The container PLC, shortly after, sends a power request to the gateway ECU at 330 and commands the battery 170 to start.

Regarding an abort of the sequence 300, the generator 100 may enter a fault status in association with an error when testing a sensitive component. In one approach, the fault status involves the activation system 190 commanding the gateway ECU to power down an FC(s) 130, closing the hydrogen valve once components are stable, and monitoring safety alarms. Here, the cooling system of the FC container 110 continues operating until the temperature returns to a target for the standby status. In particular, the activation system 190 may use liquid instead of air cooling to rapidly cool components that overheated before a fault. The HVAC also continues operating until the ambient temperature of the FC container 110 returns to a standby target. In this way, the generator 100 is at a stable temperature during the fault status. Furthermore, the activation system 190 may maintain the ignition signal to the gateway ECU for readiness to the next status transition. In addition, the container PLC may send a malfunction signal to the gateway ECU for powering down when the fault is associated with the FC container 110 or the power electronics container 120. The activation system 190 through the container PLC also communicates fault information to a human-machine interface (HMI) or BMS component for further diagnosis.

During the fault status, the activation system 190 continues sending an ON request to the BMS for cooling. In this way, the battery 170 stays cool while providing power to components and electrical buses in the generator 100. For additional temperature management, the activation system 190 also maintains coolant flow through the FC container 110 until reaching a temperature for standby. In addition, the activation system 190 sends a standby request to the BMS for readiness to the next status transition. Also, during the fault status, the HVAC closes louvers and uses fans to reduce temperature internal to the FCs 130 until reaching a standby temperature. Furthermore, the HVAC still condensates moisture within the FCs 130 until reaching a target for the moisture level. In this way, the HVAC prevents fires and water damage associated with a fault.

Returning to the sequence 300, in one approach the activation system 190 instructs the electrical bus to power the load inverter 150 and the generator inverter 160 upon completion of the startup and pre-charging of the battery 170. As such, an electrical bus coupled to the DC converters 140 is energized by the activation system 190 above a voltage level (e.g., 800 VDC) for powering the load inverter 150. The voltage level may represent minimum power before beginning a boot sequence at 340. At this time, the activation system 190 controls the DC converters 140 to increase a voltage level (e.g., 650 VDC) for the electrical bus used by the FCs 130 above a minimum. In one approach, the voltage level is an operational level for safely starting the FCs 130 and entering the generating status. Here, the DC converters 140 efficiently produce a DC voltage consistently and stably on these electrical buses from the varying DC power outputted by the FCs 130, thereby providing constant power to the load inverter 150. This regulated approach improves operation since the FCs 130 consume electricity and output excess energy.

Moreover, the activation system 190 completes the tests for sensitive components and begins testing non-critical components at 350. For example, the activation system 190 checks HVAC status, levels for reservoirs (e.g., water tanks) for the FCs 130, non-critical alarms, and data loggers. The activation system 190 uses the container PLC to then send the gateway ECU a command to startup at 360. Here, the battery 170 provides power to the DC converters 140 for the FCs 130 to startup by following an initiation sequence. In one approach, the activation system 190 instructs the FCs 130 to open fuel valves, activate pumps, adjust sensors, and set temperatures for full operation. An FC may become idle once the initiation sequence is completed. Here, idling may involve keeping a component in a low-energy or a standby state until the generator 100 reaches the generating status.

At this point, the activation system 190 completes the initiation sequence for the non-critical components. Similarly, the load inverter 150 completes the boot sequence and becomes idle. Also, the gateway ECU associated with an FC(s) 130 that completed the startup broadcasts information for status or generation. In this way, components of the generator 100 can synchronize startup, thereby preventing faults and increasing safety.

Before entering the generating status, the activation system 190 controls the container PLC to send a command for voltage control (e.g., 480 VAC) to the load inverter 150. In response, the load inverter 150 transitions and readies for outputting AC power. In one approach, the activation system 190 transitions the load inverter 150 to a mode that sets a frequency, a phase, and a voltage similar to a grid for delivering power. The activation system 190 receives a start command and begins energizing the output of the load inverter 150 for a load to a certain voltage (e.g., 480 VAC). The activation system 190 then couples the load inverter 150 to the load once the output is above a minimum voltage level (e.g., 460 VAC) to soon supply power.

In various implementations, the load continues to draw power here from the battery 170 instead of the load inverter 150. The activation system 190 controls the container PLC to measure the load and create a power request for the FCs 130. The gateway ECU sends the power request to one or more of the FCs 130 to begin power generation, matching the load demand, and transitioning the generator 100 power off from the battery 170. The generator 100 transitions to the generating status after a transient response of the FC container 110. In one approach, the battery 170 buffers the transient response by regulating the voltage levels on electrical buses drawn by the load inverter 150. Moreover, upon entering the generating status, the activation system 190 commands the generator inverter 160 to power-up for powering auxiliary load-centers of the generator 100. At 370, the generator 100 is in the generating status and uses the FCs 130 for powering a demanded load. In this way, the activation system 190 enters the generator 100 safely into the generating status by following different control sequences for the FC, the load inverter 150, and certain components.

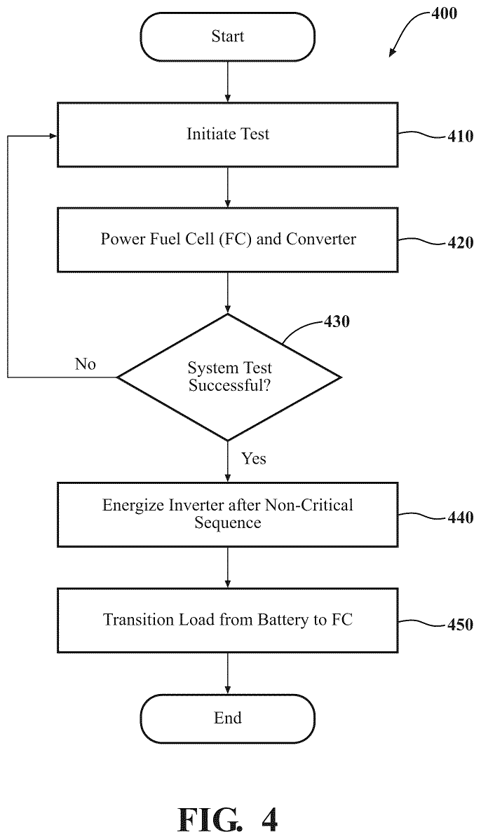

Additional aspects of the activation system 190 will be discussed in relation to FIG. 4. FIG. 4 illustrates a flowchart of a method 400 that is associated with testing, activating, transitioning to a generating status by the generator 100 having the FCs 130. Method 400 will be discussed from the perspective of the activation system 190 of FIG. 2. It should be appreciated that the method 400 is not limited to being implemented within the activation system 190 but is instead one example of a system that may implement the method 400. In particular, the activation system 190 controls the generator 100 to test, activate, and transition components associated with the FCs 130 and the generator 100 using a control sequence for entering a generating status. By following the control sequence, the activation system 190 increases the durability, safety, and lifespan of the generator 100.

At 410, the activation system 190 initiates a test for the sensitive components of the generator 100. As explained above, this testing may use power from the UPS 180 and ignition systems. As such, the tests check proper operations of alarms, the container PLC, FC subsystems, cooling temperature, gas pressure/levels, and low-voltage power supplies. An error, no response, or abnormal operation here will cause a startup to abort. The generator 100 may also enter a fault status due to a related malfunction. In this way, the activation system 190 protects sensitive components of the generator 100 from damage.

At 420, the activation system 190 begins powering the FCs 130 and the DC converters 140. As explained above, the DC converters 140 begin increasing a voltage level for an electrical bus used by the FCs 130 by drawing power from the battery 170. Here, the DC converters 140 produce a DC voltage that is balanced and stable on different electrical buses from the varying DC power outputted by the FCs 130, thereby providing constant power to the load inverter 150. Balancing of voltage on the electrical buses also addresses irregular power draws by the FCs 130.

Furthermore, at this point the FCs 130 follow an initiation sequence that opens fuel valves, activates pumps, adjusts sensors, and sets temperatures for full operation. An FC may become idle once the initiation sequence is completed. Here, idling may involve keeping a component in a low-energy state until the generator 100 reaches the generating status.

At 430, the activation system 190 completes the test for the sensitive components. If the test does not generate an error code or irregular status, the activation system 190 begins testing non-critical components by following a non-critical sequence. For example, the activation system 190 checks HVAC status, levels for reservoirs (e.g., water reservoirs) for the FCs 130, non-critical alarms, and data loggers. Upon an error or irregular status, the activation system 190 aborts the sequence and performs another test or enters the fault status described above.

At 440, the activation system 190 energizes the load inverter 150 upon completion of the non-critical sequence. As such, the electrical buses coupled to the DC converters 140 are energized by the activation system 190 above a voltage level for the load inverter 150 powering a load (e.g., a building or device). At this time, the DC converters 140 begin increasing a voltage level for the electrical bus used by the FCs 130 above a minimum level. In one approach, the voltage level is an operational level for safely starting the FCs 130 and entering the generating status.

At 450, the activation system 190 transitions a load from the battery 170 to the FCs 130 for power generation. In accordance with this operation, the activation system 190 uses the container PLC to measure the load and send a power request to the FCs 130. One or more of the FCs 130 begin energization and matching the load demand for transitioning power to the load off the battery 170. Furthermore, the generator 100 transitions to the generating status after a transient response of the FC container 110. In one approach, the activation system 190 controls the battery 170 to buffer the transient response by regulating the voltage levels on electrical buses drawn by the load inverter 150. In this way, the activation system 190 powers the load consistently and protects sensitive components from irregular voltages.

Detailed embodiments are disclosed herein. However, it is to be understood that the disclosed embodiments are intended as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Furthermore, the terms and phrases used herein are not intended to be limiting but rather to provide an understandable description of possible implementations. Various embodiments are shown in FIGS. 1-4, but the embodiments are not limited to the illustrated structure or application.

The flowcharts and block diagrams in the figures illustrate the architecture, functionality, and operation of possible implementations of systems, methods, and computer program products according to various embodiments. In this regard, a block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Examples of such a computer-readable medium may include, but are not limited to, a floppy disk, a flexible disk, a hard disk, a magnetic tape, another magnetic medium, an application-specific integrated circuit (ASIC), a CD, another optical medium, a RAM, a ROM, a memory chip or card, a memory stick, and other media from which a computer, a processor or other electronic device can read. In the context of this document, a computer-readable storage medium may be any tangible medium that can contain, or store a program for use by or in connection with an instruction execution system, apparatus, or device.

The following includes definitions of selected terms employed herein. The definitions include various examples and/or forms of components that fall within the scope of a term and that may be used for various implementations. The examples are not intended to be limiting. Both singular and plural forms of terms may be within the definitions.

References to “one embodiment,” “an embodiment,” “one example,” “an example,” and so on, indicate that the embodiment(s) or example(s) so described may include a particular feature, structure, characteristic, property, element, or limitation, but that not every embodiment or example necessarily includes that particular feature, structure, characteristic, property, element, or limitation. Furthermore, repeated use of the phrase “in one embodiment” does not necessarily refer to the same embodiment, though it may.

“Module,” as used herein, includes a computer or electrical hardware component(s), firmware, a non-transitory computer-readable medium that stores instructions, and/or combinations of these components configured to perform a function(s) or an action(s), and/or to cause a function or action from another logic, method, and/or system. Module may include a microprocessor controlled by an algorithm, a discrete logic (e.g., ASIC), an analog circuit, a digital circuit, a programmed logic device, a memory device including instructions that, when executed perform an algorithm, and so on. A module, in one or more embodiments, includes one or more CMOS gates, combinations of gates, or other circuit components. Where multiple modules are described, one or more embodiments include incorporating the multiple modules into one physical module component. Similarly, where a single module is described, one or more embodiments distribute the single module between multiple physical components.

Additionally, module, as used herein, includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an ASIC, a hardware component of a system on a chip (SoC), as a programmable logic array (PLA), or as another suitable hardware component that is embedded with a defined configuration set (e.g., instructions) for performing the disclosed functions.

In one or more arrangements, one or more of the modules described herein can include artificial or computational intelligence elements, e.g., neural network, fuzzy logic, or other machine learning algorithms. Further, in one or more arrangements, one or more of the modules can be distributed among a plurality of the modules described herein. In one or more arrangements, two or more of the modules described herein can be combined into a single module.

Program code embodied on a computer-readable medium may be transmitted using any appropriate medium, including but not limited to wireless, wireline, optical fiber, cable, radio frequency (RF), etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a standalone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all combinations of one or more of the associated listed items. As an example, the phrase “at least one of A, B, and C” includes A, B, C, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. An activation system, comprising:
one or more processors; and
a memory communicably coupled to the one or more processors and storing:
a control module including instructions that, when executed by the one or more processors, cause the one or more processors to:
initiate a test for sensitive systems of a generator during a standby status using backup power including a battery;
power a fuel cell (FC) and a direct current (DC) converter on a first bus within the generator by increasing an operational voltage on a second bus using the battery; and
upon successfully completing the test and powering the FC and the DC converter, energize a load inverter by switching power flow from the battery to the FC after completion of a non-critical sequence that controls support systems of the generator for a generating status, wherein the DC converter stabilizes voltage energy between the FC directly connected on the first bus above a minimum voltage and output energy to the second bus, and the second bus is directly connected to the battery and the load inverter and output power from the FC matches a load demand on the second bus.

2. The activation system of claim 1 further including instructions to startup, upon successfully completing the test that includes to open a fuel valve and pump activation associated with the FC, the FC directly after an initiation sequence and the load inverter according to a boot sequence and enter a startup status that both run in parallel.

3. The activation system of claim 2 further including instructions to transition the load inverter from being powered by the battery to the FC after completion of the initiation sequence and the boot sequence, wherein the FC broadcasts completion of the initiation sequence to the sensitive systems and non-critical components.

4. The activation system of claim 2 further including instructions to startup, by the generator during the initiation sequence, the support systems that manage temperature and water of the FC according to the non-critical sequence, wherein the initiation sequence and the boot sequence continue with an error during the non-critical sequence.

5. The activation system of claim 1 further including instructions to:
energize by the load inverter an output to an alternating current (AC) level for feeding a load; and
connect the load inverter directly to the load and switch the generator to the generating status, wherein the generating status includes a generator inverter directly connected to the second bus powering non-critical components of the FC and auxiliary load-centers of the generator using the FC.

6. The activation system of claim 1 further including instructions to communicate a request to the FC and another FC coupled to a third bus and the second bus using another DC converter to match a power demand of a load after energizing the load inverter.

7. The activation system of claim 1, wherein the DC converter stabilizes the first bus for the FC at a first voltage and the second bus stabilizes at a second voltage using the battery.

8. A non-transitory computer-readable medium comprising:
instructions that when executed by a processor cause the processor to:
initiate a test for sensitive systems of a generator during a standby status using backup power including a battery;
power a fuel cell (FC) and a direct current (DC) converter on a first bus within the generator by increasing an operational voltage on a second bus using the battery; and
upon successfully completing the test and powering the FC and the DC converter, energize a load inverter by switching power flow from the battery to the FC after completion of a non-critical sequence that controls support systems of the generator for a generating status, wherein the DC converter stabilizes voltage energy between the FC directly connected on the first bus above a minimum voltage and output energy to a second bus, and the second bus is directly connected to the battery and the load inverter and output power from the FC matches a load demand on the second bus.

9. The non-transitory computer-readable medium of claim 8 further including instructions to startup, upon successfully completing the test that includes to open a fuel valve and pump activation associated with the FC, the FC directly after an initiation sequence and the load inverter according to the boot sequence and enter a startup status that both run in parallel.

10. The non-transitory computer-readable medium of claim 9 further including instructions to transition the load inverter from being powered by the battery to the FC after completion of the initiation sequence and the boot sequence, wherein the FC broadcasts completion of the initiation sequence to the sensitive systems and non-critical components.

11. The non-transitory computer-readable medium of claim 9 further including instructions to startup, by the generator during the initiation sequence, the support systems that manage temperature and water of the FC according to the non-critical sequence, wherein the initiation sequence and the boot sequence continue with an error during the non-critical sequence.

12. The non-transitory computer-readable medium of claim 8 further including instructions to:
energize by the load inverter an output to an alternating current (AC) level for feeding the load; and
connect the load inverter directly to the load and switch the generator to the generating status, wherein the generating status includes a generator inverter directly connected to the second bus powering non-critical components of the FC and auxiliary load-centers of the generator using the FC.

13. The non-transitory computer-readable medium of claim 8 further including instructions to communicate a request to the FC and another FC coupled to a third bus and the second bus using another DC converter to match a power demand of the load after energizing the load inverter.

14. A method comprising:
initiating a test for sensitive systems of a generator during a standby status using backup power including a battery;
powering a fuel cell (FC) and a direct current (DC) converter on a first bus within the generator by increasing an operational voltage on a second bus using the battery; and
upon successfully completing the test and powering the FC and the DC converter, energizing a load inverter by switching power flow from the battery to the FC after completing a non-critical sequence that controls support systems of the generator for a generating status, wherein the DC converter stabilizes voltage energy between the FC directly connected on the first bus above a minimum voltage and output energy to the second bus, and the second bus is directly connected to the battery and the load inverter and output power from the FC matches a load demand on the second bus.

15. The method of claim 14 further comprising:
upon successfully completing the test that includes opening a fuel valve and activating a pump associated with the FC, starting up the FC directly after an initiation sequence and the load inverter according to the boot sequence and entering a startup status both running in parallel.

16. The method of claim 15 further comprising:
transitioning the load inverter from being powered by the battery to the FC after completion of the initiation sequence and the boot sequence, wherein the FC broadcasts completion of the initiation sequence to the sensitive systems and non-critical components.

17. The method of claim 15 further comprising:
starting up, by the generator during the initiation sequence, the support systems that manage temperature and water of the FC according to the non-critical sequence, wherein the initiation sequence and the boot sequence continue with an error during the non-critical sequence.

18. The method of claim 14 further comprising:
energizing by the load inverter an output to an alternating current (AC) level for feeding the load; and
connecting the load inverter directly to the load and switching the generator to the generating status, wherein the generating status includes a generator inverter directly connected to the second bus powering non-critical components of the FC and auxiliary load-centers of the generator using the FC.

19. The method of claim 14 further comprising:
communicating a request to the FC and another FC coupled to a third bus and the second bus using another DC converter to match a power demand of the load after energizing the load inverter.

20. The method of claim 14, wherein the DC converter stabilizes the first bus for the FC at a first voltage and the second bus for the load inverter at a second voltage using the battery.
